(19) United States
(12) Patent Application Publication
(10) Pub. No.: US 2022/0351256 A1
(43) Pub. Date: Nov. 3, 2022

(54) COMPUTER IMPLEMENTED SYSTEM AND METHOD OF PROVIDING CUSTOMER SUPPORT IN-STORE

(71) Applicants: Allan MALCOMSON, Richmond (CA); Elizabeth MALCOMSON, Ottawa (CA)

(72) Inventors: Allan MALCOMSON, Richmond (CA); Elizabeth MALCOMSON, Ottawa (CA)

(21) Appl. No.: 17/716,238

(22) Filed: Apr. 8, 2022

Related U.S. Application Data
(60) Provisional application No. 63/181,482, filed on Apr. 29, 2021.

(30) Foreign Application Priority Data
Jun. 22, 2021 (CA) 3122936

(51) Int. Cl. G06Q 30/02; G06Q 30/00; H04W 4/33; H04W 4/80; G06Q 30/06

(52) U.S. Cl. CPC G06Q 30/0281; G06Q 30/016; H04W 4/33; H04W 4/80; G06Q 30/0601

(57) ABSTRACT

The invention provides computer implemented system and method of providing customer support in-store. The system and method utilize a plurality of customer service call buttons placed throughout the store that allow a customer to call for help.

### CROSS-REFERENCE TO RELATED APPLICATIONS

This application claims priority to U.S. Provisional Application No. 63/181,482, filed on Apr. 29, 2021, and to Canadian Patent Application No. 3,122,936 filed Jun. 22, 2021. The foregoing applications are incorporated by reference herein in their entirety.

### FIELD OF THE INVENTION

The present invention relates to in-store customer support. In particular, a computer implemented system and method of providing customer support in-store.

### BACKGROUND OF THE INVENTION

In-store customer experience impacts a store's sales. A positive experience can lead to more sales while a negative experience can result in a loss of sales. Store design and layout, product placement and labelling and employee engagement with customers can enhance a customer's in-store experience.

Promoting positive customer-employee engagement requires getting the right employee to a customer seeking help in a timely manner. A clear view of the whole store floor may facilitate identification of customers in need of employee assistance but is impractical in stores with a large footprint and/or floor to ceiling shelving. Accordingly, there exists a need for a system and method to pair customers in need of assistance with employees that can provide appropriate assistance.

Positive employee-customer interactions can be promoted by incentivizing employees to provide positive in-store customer experiences. Relying on positive customer feedback to incentivize employees does not provide a complete picture of the employee-customer interaction. Accordingly, there exists a need for a system and method to track the outcome of customer-employee interactions.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a computer implemented system and method of providing customer support in-store. In accordance with an aspect of the present invention, there is provided a wireless communication system for in-store customer support, the system comprising: a wireless network; one or more wireless call buttons for initiating a request for customer support; each wireless call button operatively associated with the network, each call button provided with a unique identifier and having an activation button; a memory operatively connected to the network having a database stored thereon, the database comprising a record for each call button; each record comprising the unique identifier, location of the call button and other information; a processor configured to monitor for activation of a call button and transmit in response to an activation a call signal via the wireless network to one or more mobile computing devices carried by customer service employees; and the one or more mobile computing device having a wireless transceiver that is capable of receiving the call signal and that provides an alert on the one or more mobile computing devices upon receiving the call signal.

In accordance with another aspect of the invention, there is provided a method for dispatching a customer service employee to a customer in-store requiring assistance and to log information regarding customer-employee interaction, the method comprising: providing a plurality of customer service call buttons operatively associated with a network, each call button provided with a unique identifier and having an activation button; storing in a memory operatively connected to the network a database comprising a record for each call button; each record comprising location of the call button and other information; monitoring the network for activation of a call button via a network computing device; generating a call to dispatch a customer service employee to the call button when the call button is activated; transmitting a call signal via a wireless network to a mobile computing device carried by one of customer service employees; tracking the time between the call signal and a call acceptance signal that is generated in response to an action taken by the employee at a user interface on the mobile computing device; tracking the time between the call acceptance signal and a call arrival signal that is generated in response to an action taken by the customer service employee at the user interface on the mobile computing device when the customer service employee arrives at the activated call button; tracking the time between the call arrival signal and a call finish signal that is generated in response to an action taken by the customer service employee at the user interface on the mobile computing device;
optionally tracking outcome of the call;
storing the tracked times in a memory operatively connected to the network computing device; and tracking the number of times a call signal has been generated for the activated call button.

### BRIEF DESCRIPTION OF THE DRAWINGS

These and other features of the invention will become more apparent in the following detailed description in which reference is made to the appended drawings.

FIG. 1 illustrates request work flow of an embodiment of the present invention.

FIG. 2 illustrates a display comprising a network connected call button in accordance with an embodiment of the present invention.

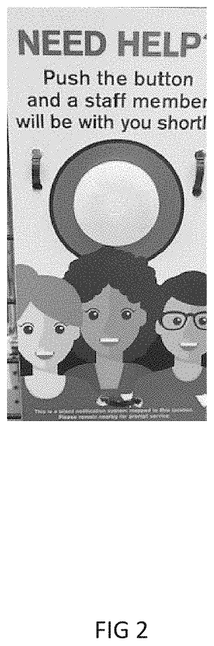

FIG. 3 illustrates a pop-up alert/call received on a mobile computing device carried by a customer service employee detailing department and any required skill or authorization, i.e. keys to unlock a display.

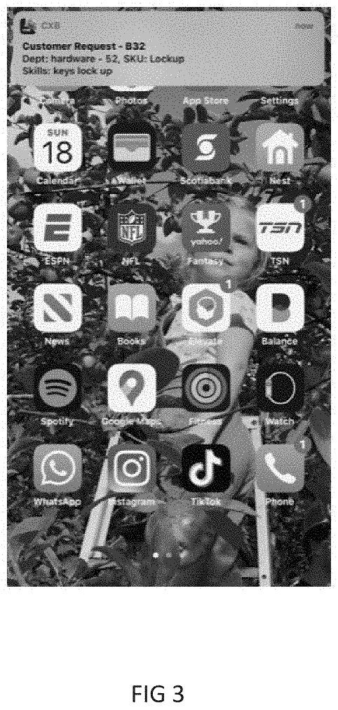

FIG. 4 illustrates the user interface on the mobile computing device carried by the customer service employee detailing timer and option to delete notification or indicate that the service employee will respond to call.

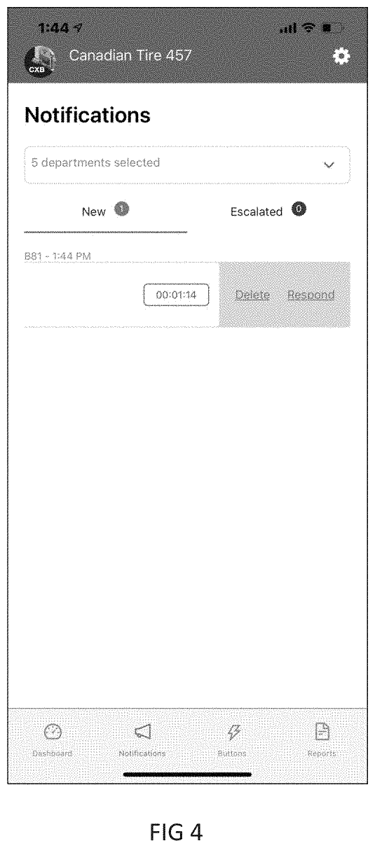

FIG. 5 illustrates the user interfaces on the mobile computing device carried by the customer service employee who has accepted the call to close the call. The interface shows the option to mark call complete, the second interface shows the options to detail outcome of the call, and the third interface shows interface allowing a customer service employee to see other notifications once call is closed.

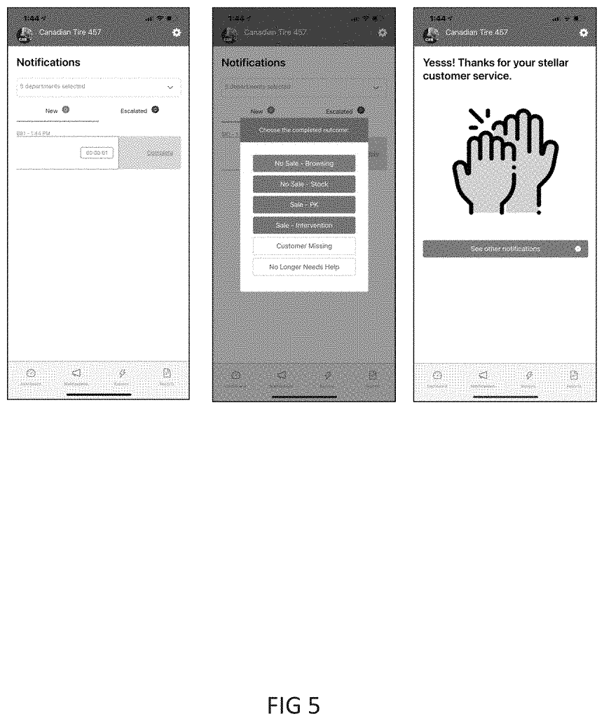

FIG. 6 illustrates the notification screen detailing multiple notifications.

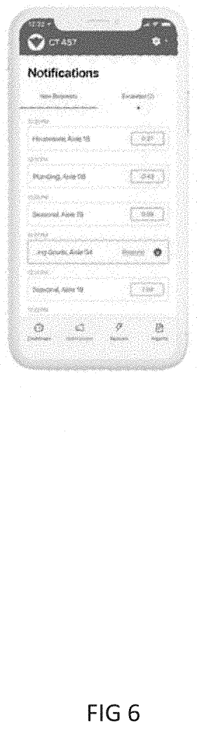

FIG. 7 illustrates a listing of network connected call button (also called beacons) with location.

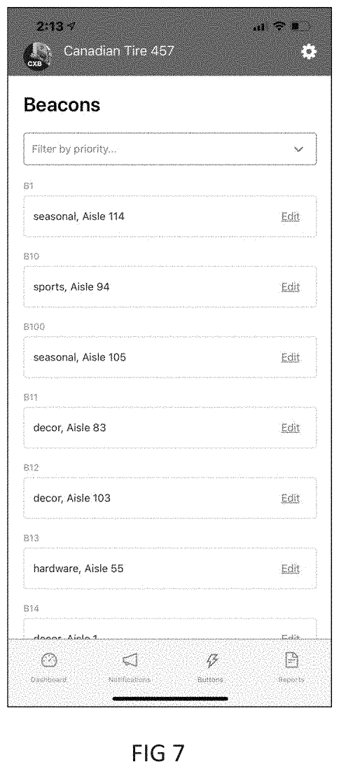

FIG. 8 illustrates optional welcome screens for a user application on a mobile computing device.

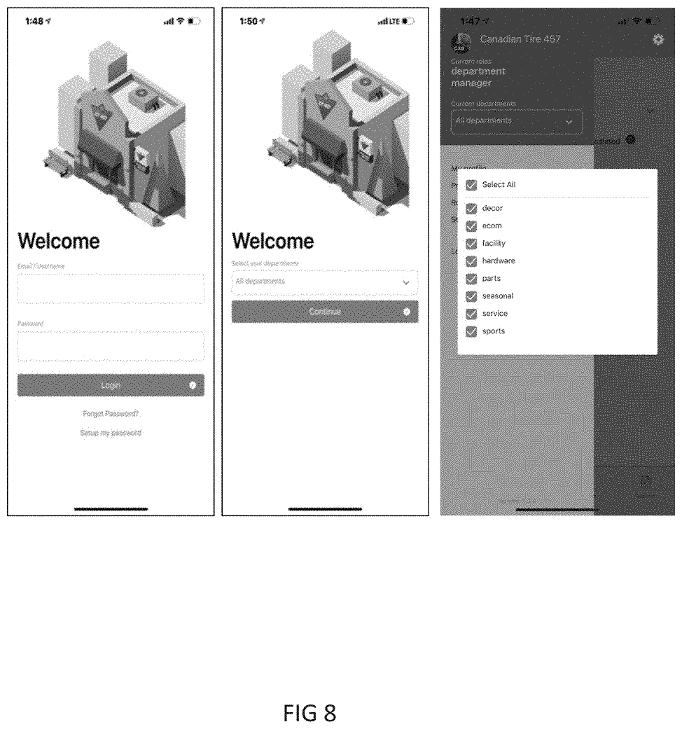

FIG. 9 illustrates profile set up screen for a user application on a mobile computing device.

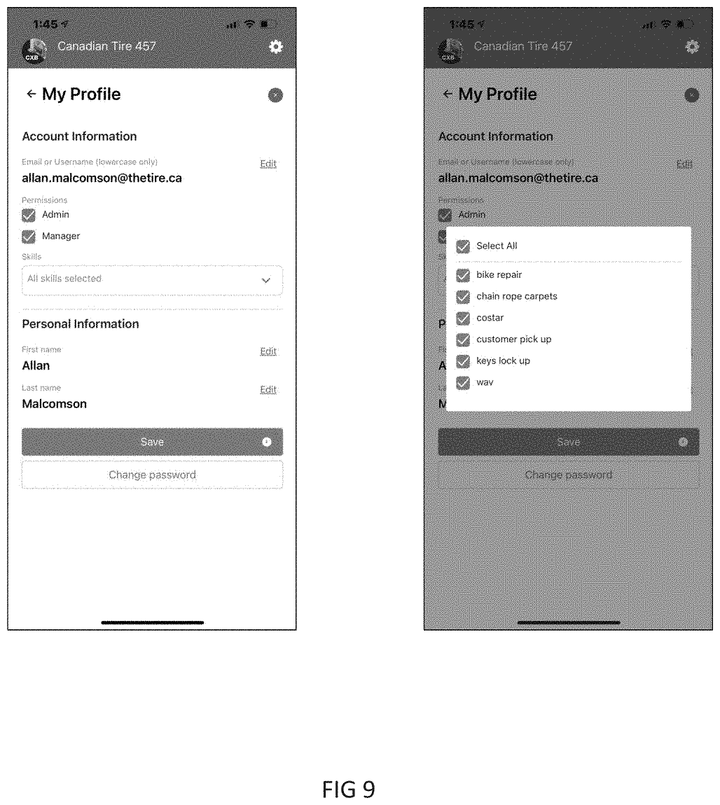

FIG. 10 illustrates a user interface for modifying call button characteristics.

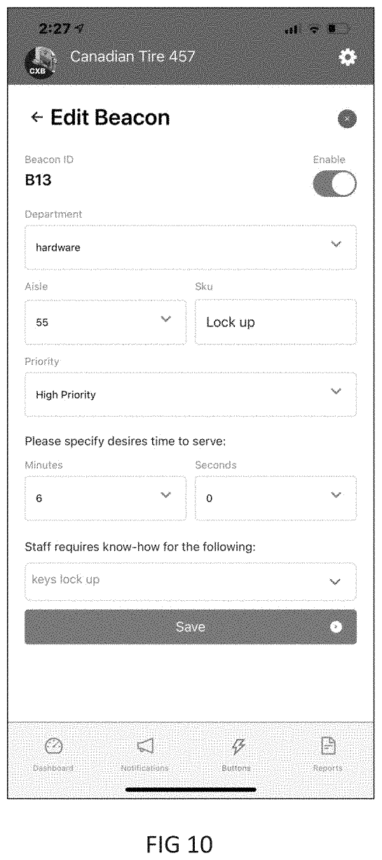

FIG. 11 illustrates a reporting screen in an embodiment of the invention.

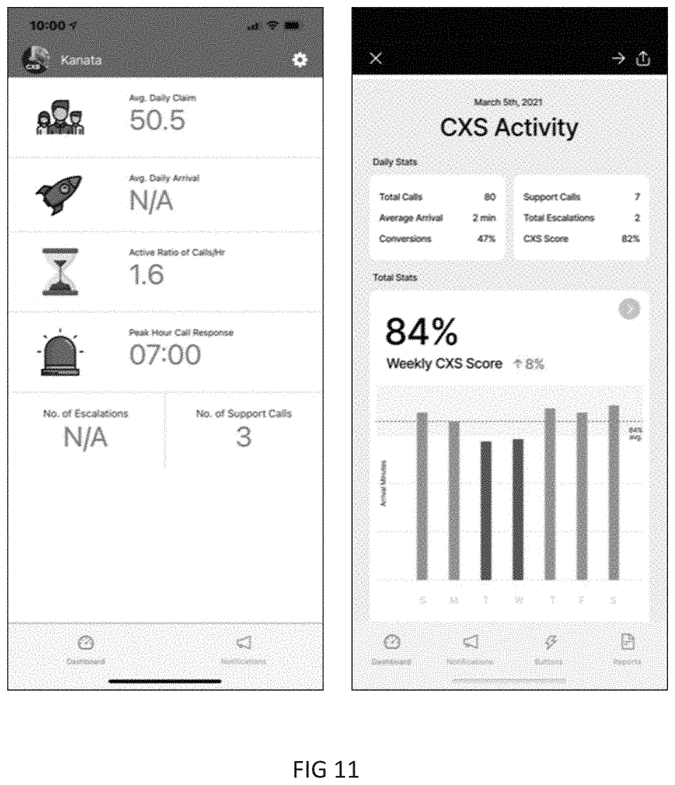

FIG. 12 illustrates a reporting screen in an embodiment of the invention.

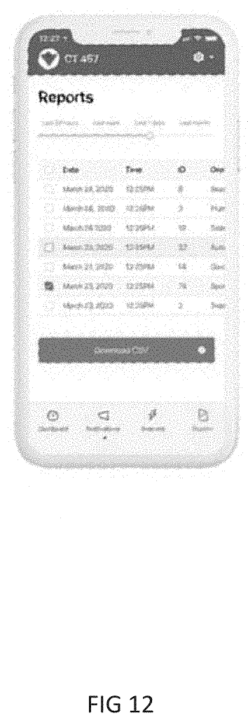

### DETAILED DESCRIPTION OF THE INVENTION

The present invention provides a system and method of providing in-store customer support wherein customers are able to summon support when needed. In particular, there is provided a system and method in which a customer service employee equipped with a mobile computing device selected from a smart phone, smart watch and tablet is dispatched to a customer who has requested support. The customer initiates a service request by activating a network connected call button. Upon activation of the call, a notification or alert is sent to the mobile computing devices of one or more employees indicating that a customer requires assistance at a specific call button. In some embodiments, a notification or alert is sent to all customer service employees. In other embodiments, a notification or alert is only sent to customer services employees who are not already responding to a request for support or who have marked in the system that they are unavailable to respond to such requests. In other embodiments, a notification or alert is sent to a subset of employees, optionally the subset of employees are employees with a specific skill set, knowledge base or authorization level, for example, to access a locked display, who are more likely be able to best assist the customer requesting support.

In some embodiments, all customer service employees are provided with a store-issued smart phone with app installed. Optionally, managers are also provided with store-issued smart phones. Optionally, the system and method provide a sign-up page that allows customer service employees to identify specific skill sets and/or their role in the store. The system and method may further require each employee to log on at the start of each shift.

The number and location of call buttons will depend on store layout and size among other factors. Generally, the location of the call buttons will be well labelled and easy to access. Call buttons may be located at ends of aisles. The layout, location and number of call buttons may be modified after specific periods of use or in response to seasonal changes in products. Call buttons that are not or rarely used may be removed and may optionally relocated to higher traffic areas.

Network connected call buttons are known in the art and include Bluetooth® enabled call buttons. Each call button is assigned a unique identifier. When initiated, optionally using a mobile computing device, the call button is assigned a location within the store either by manually entering the location of the call button or by using a real time locating system. Real time locating systems are known in the art and use RTLS reference points and tags.

Optionally, the method and system provide a map overlaying call button location on a store layout. In some embodiments, the map can be interactive wherein additional information about each call button including details regarding location, status of call button including activation status and battery (low battery alert) or charge status, activity, etc. can be obtained by clicking on the call button marker on the map. In some embodiments, the map is linked to store security cameras such that a real time image of the call button environs can be accessed by clicking on the call button marker.

Optionally, the network connected call buttons are equipped with two-way communication capabilities such that communication between the customer and a store employee may occur. In some embodiments, the network connected call button may include or is operatively associated with a means of capturing a digital image such that an image of the customer may be captured to facilitate identification of the customer requesting service.

In some embodiments, the network connected call buttons are configured as pressable buttons. In other embodiments, the network connected call buttons are icons on a touch screen.

The call button unique identifier, location and other relevant information are stored in a searchable database. Other relevant information may include products for sale proximal to the tag and if access to products proximal to the call button is restricted, for example, are located within a locked display.

The notification or alert includes at least an identification of the call button that was activated and may optionally include a timer to indicate time elapsed from call button being activated. Optionally, the method and system are configured to sent a second alert if a specific amount of time has elapsed since call button was activated. In some embodiments, the method and system is configured to send a high priority alert, optionally to a manager, if time elapsed since call button was activated is deem to be too long.

Optionally, specific call buttons can send higher priority alerts depending on location of the call buttons, for example, call buttons located proximal to high value or high demand items may be given a higher priority than lower value items.

In some embodiments, other additional information may be provided as part of the alert including, for example, if a specialized skill or authorization will likely be required or if the call button is in proximity to a locked display. In some embodiments, the alert provides prompts to the responding customer service employee about possible add on items. For example, if the activated call button is proximal to paints, the prompt could include a reminder to ask the customer if they need paint brushes or masking material or if the activated call button is proximal to light fixtures, the prompt could include a reminder to ask the customer if they need light bulbs.

In some embodiments and if available, a digital image of the individual activating the call button may be included on the alert or notification.

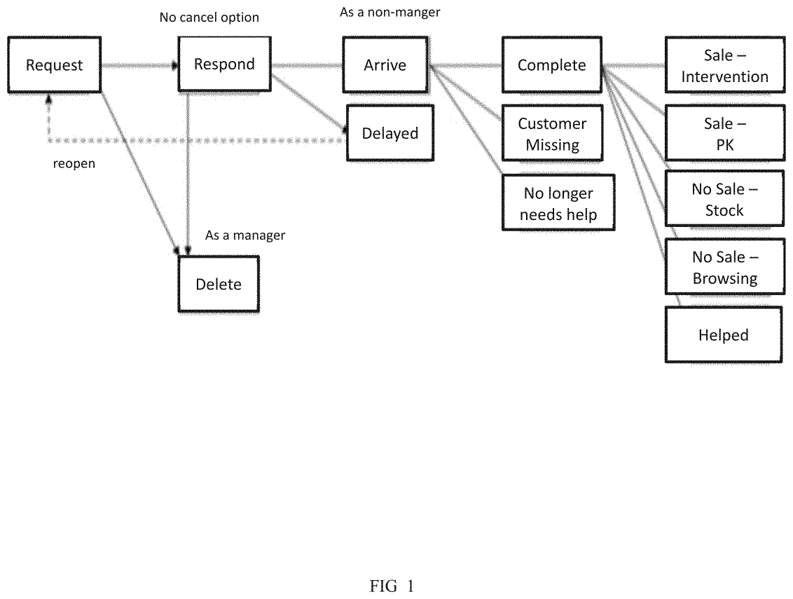

Referring to FIG. 1, in some embodiments, upon activation of the call button, an alert is sent and accepted by a customer service employee. If after acceptance of the service request by the customer service employee, the employee is waylaid by a different customer, the customer service employee has the option of cancelling the acceptance of the service request using their assigned mobile computing device. If the responding customer service employee cancels the acceptance, the alert will be re-sent optionally at a higher priority level.

Upon arrival, the customer service employee using their assigned mobile computing device will note their arrival at the call button. Alternative, in some embodiments, the call button will be configured to automatically note proximity of the responding customer service employee to the call button. If upon arrival the customer is not located or no longer needs assistance, the responding customer service employee using their assigned mobile computing device will note the same in the system.

The system and method optionally allow the customer service employee to retrieve information regarding the specific type of help the customer requires. In some embodiments, this will include an estimate of the length of time to complete an action.

If the customer requires assistance, the method and system will optionally track length of time required to assist the customer and the outcome of the interaction including a sale, no stock, no sale, question answered, hand off to manager amongst other outcomes. In some embodiments, the system and method provide an alert if a customer-customer service employee interaction appears to be taking too long based on standard interaction times. The system and method may optionally provide the customer service employee an opportunity to provide a follow-on action in view of the request, for example, request a re-stock or an update to shelf labelling.

The system and method are configurable to provide reports and analytics to management. Reports and analytics optionally include details regarding frequency of call button use, average response time overall, average response time to a specific call button, average interaction time and average interaction time at a specific button. Reports and analytics may be customer service employee specific and may be used to reward employees who frequently close sales. Reports and analytics may also be used to identify employees who are slow to respond to calls and/or take longer than expected at a customer call.

The reports and analytics may be used to identify areas in store to adjust staffing levels and/or improve signage.

Access to reports and analytics is optionally restricted to an employee's role. Accordingly, the system and method provide for an option to limit access.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

We claim:

1. A wireless communication system for in-store customer support, the system comprising:
a wireless network;
one or more wireless call buttons for initiating a request for customer support; each wireless call button operatively associated with the network, each call button provided with a unique identifier and having an activation button;
a memory operatively connected to the network having a database stored thereon, the database comprising a record for each call button; each record comprising the unique identifier, location of the call button and other information;
a processor configured to monitor for activation of a call button and transmit in response to an activation a call signal via the wireless network to one or more mobile computing device carried by customer service employees; and
the one or more mobile computing device having a wireless transceiver that is capable of receiving the call signal and that provides an alert on the one or more mobile computing devices upon receiving the call signal.

2. The system of claim 1, wherein the one or more wireless call buttons and/or mobile computing devices are Bluetooth-enabled.

3. The system of claim 1 or 2, wherein the one or more wireless call buttons are configured to provide a call status update and/or are configured for two-way communication.

4. The system of claim 1, wherein the processor is configured to generate a call log.

5. The system of claim 1, wherein the system is configured to send the call signal to a subset of available mobile computing devices.

6. A method for dispatching a customer service employee to a customer in-store requiring assistance and to log information regarding customer-employee interaction, the method comprising: providing a plurality of customer service call buttons operatively associated with a network, each call button provided with a unique identifier and having an activation button;
storing in a memory operatively connected to the network a database comprising a record for each call button; each record comprising location of the call button and other information;
monitoring the network for activation of a call button via a network computing device;
generating a call to dispatch a customer service employee to the call button when the call button is activated;
transmitting a call signal via a wireless network to a mobile computing device carried by one of customer service employees;
tracking the time between the call signal and a call acceptance signal that is generated in response to an action taken by the employee at a user interface on the mobile computing device; tracking the time between the call acceptance signal and a call arrival signal that is generated in response to an action taken by the customer service employee at the user interface on the mobile computing device when the customer service employee arrives at the activated call button;
tracking the time between the call arrival signal and a call finish signal that is generated in response to an action taken by the customer service employee at the user interface on the mobile computing device;
optionally tracking outcome of the call;
storing the tracked times in a memory operatively connected to the network computing device;
and tracking the number of times a call signal has been generated for the activated call button.

7. The method of claim 6; wherein the call signal includes data that identifies the activated call button.
